(19) United States
(12) Patent Application Publication
(10) Pub. No.: US 2010/0316937 A1
(43) Pub. Date: Dec. 16, 2010

(54) ALLOY CATALYST FOR REDOX REACTION

(76) Inventors: Ryogo SAKAMOTO, Wako-shi (JP); Kaoru Omichi, Wako-shi (JP); Masao Ichikawa, Wako-shi (JP)

Correspondence Address: Capitol City TechLaw, PLLC, 113 S. Columbus St., Suite 302, Alexandria, VA, 22314, US

(21) Appl. No.: 12/813,141

(22) Filed: Jun. 10, 2010

(30) Foreign Application Priority Data
Jun. 11, 2009 (JP) 2009-140180
Apr. 27, 2010 (JP) 2010-102191

(51) Int. Cl. H01M 4/92; B01J 23/89

(52) U.S. Cl. 429/524; 502/326

(57) ABSTRACT

An alloy catalyst for redox reaction which is capable of obtaining even superior catalytic activity comprises alloy particles of platinum and nickel, wherein the alloy particle is equipped at an outer surface with a crystal lattice plane represented by a Miller index {111}, and has an average particle diameter in a range of from 6 to 20 nm. The alloy particle preferably takes a shape selected from a regular octahedron, a truncated octahedron, a regular tetrahedron, and a truncated tetrahedron.

This application claims the foreign priority benefit under 35 U.S.C. §119 of Japanese Patent Applications Nos. 2009-140180 filed on Jun. 11, 2009, and 2010-102191 filed on Apr. 27, 2010, the complete disclosures of which are incorporated herein by reference.

### BACKGROUND OF THE INVENTION

1. Field of the Invention

The present invention relates to an alloy catalyst for redox reaction used as, for example, an electrode catalyst for a hydrogen-oxygen fuel cell.

2. Description of the Related Art

Conventionally, there is known a hydrogen-oxygen fuel cell equipped with an electrolyte layer sandwiched by electrode catalyst layers. In the hydrogen-oxygen fuel cell, when hydrogen gas which is a reducing gas is introduced to an anode electrode, the hydrogen gas generates protons by the action of the catalyst in the electrode catalyst layer, as is shown in formula (1). The generated protons move to the electrode catalyst layer on a cathode electrode side via the electrolyte layer.

On the other hand, when hydrogen gas is introduced to the anode electrode and oxygen gas which is an oxidized gas is introduced to the cathode electrode, the protons generate water by reacting with the oxygen gas by the action of the catalyst in the electrode catalyst layer on the cathode electrode side, as is shown in formula (2). By connecting the cathode electrode and the anode electrode with a conducting wire, electric current may be taken out. At this time, each electrode catalyst layer acts as a catalyst for redox reaction for generating the reaction in formula (1) and (2).

Anode electrode: 2H2 →>4H⁺+4e⁻ (1)

Cathode electrode: O₂₊₄H⁺+4e^{-→2}H₂O (2)

As this type of catalyst for redox reaction, a platinum catalyst is known. However, the platinum catalyst is expensive, and reduction of the amount of use of platinum is desired. As such, as a catalyst for redox reaction decreasing the amount of use of platinum, there is disclosed a platinum-nickel alloy catalyst (refer to Japanese Patent Laid-Open No. S64-45061). According to an X-ray diffraction, this platinum-nickel alloy catalyst contains approximately 50 atomic % of nickel in the alloy, and has a particle diameter of 4.8 nm. Further, it is said that this platinum-nickel alloy catalyst is equipped with 1.4 times higher catalytic activity compared to the platinum alloy of the same weight.

However, for the alloy catalyst for redox reaction, it is desired that the catalyst is equipped with even superior catalytic activity.

### SUMMARY OF THE INVENTION

In view of such circumstances, an object of the present invention is to provide an alloy catalyst for redox reaction which is capable of obtaining even superior catalytic activity.

The present inventors have made various studies on catalytic activity of the alloy catalyst for redox reaction consisting of alloy particles of platinum and nickel. As a result, the present inventors have found that the alloy catalyst for redox reaction consisting of alloy particles of platinum and nickel shows superior catalytic activity, when the alloy particle is equipped at the outer surface with a crystal lattice plane represented by a specific Miller index, and also has a specific average particle diameter, and reached to the present invention.

In order to achieve the above object, the present invention provides an alloy catalyst for redox reaction comprising alloy particles of platinum and nickel, wherein the alloy particle is equipped at an outer surface with a crystal lattice plane represented by a Miller index {111}, and has an average particle diameter in a range of from 6 to 20 nm.

The alloy particle of the alloy catalyst for redox reaction of the present invention has the average particle diameter in the above-mentioned range, so that it is possible to be equipped at the outer surface with the crystal lattice plane represented by the Miller index {111} in a ratio sufficient for obtaining superior catalytic activity. The crystal lattice plane represented by the Miller index {111} means plane groups equivalent to the crystal lattice plane represented by the Miller index (111), and includes the crystal lattice plane represented by the Miller indices (−111), (1-11), (11-1), and the like.

The crystal lattice plane represented by the Miller index {111} has larger number of atoms per unit area compared to other crystal lattice planes, and atoms exist densely, so that it is possible to suppress entry of oxygen species from the surface of the particle to inside thereof. The oxygen species are chemical species which cause elution of platinum, and includes oxygen atom, hydroxy-ion and the like.

Further, the alloy particle has the average particle diameter in the above-mentioned range, so that a catalytic active surface area per unit weight is small compared to alloy particles having the average particle diameter under 6 nm.

As a result, the alloy catalyst for redox reaction of the present invention is unlikely to cause Ostwald growth of the particle caused by elution and reprecipitation of platinum from the surface of the alloy particle, so that it is superior in stability to repetition of electrochemical redox reaction, and is capable of suppressing decrease in catalytic activity.

When the average particle diameter of the alloy particle of the alloy catalyst for redox reaction of the present invention is under 6 nm, it is not possible to be equipped at the outer surface with the crystal lattice plane represented by the Miller index {111} in a ratio sufficient for obtaining superior catalytic activity. Further, in the case where the average particle diameter of the alloy particle is under 6 nm, particle growth of the alloy particle becomes larger with the repetition of the electrochemical redox reaction, so that the catalytic activity decreases significantly.

On the other hand, the alloy catalyst for redox reaction of the present invention cannot have increased effect when the average particle diameter of the alloy particle exceeds 20 nm.

In the present invention, it is preferable that the alloy particle takes a shape selected from any one of a regular octahedron, a truncated octahedron, a regular tetrahedron, and a truncated tetrahedron. The truncated octahedron is a shape in which each apex of the regular octahedron is cut off, and the truncated tetrahedron is a shape in which each apex of the regular tetrahedron is cut off. According to the alloy catalyst for redox reaction of the present invention, by making the alloy particle take any one of the above-mentioned shapes, it becomes possible to be equipped at the outer surface with the crystal lattice plane represented by the Miller index {111}, and have superior catalytic activity.

### BRIEF DESCRIPTION OF THE DRAWINGS

The accompanying drawings are included to provide a further understanding of the present disclosure and are incorporated in and constitute a part of this specification, illustrate various embodiments of the present disclosure and together with the detailed description serve to explain the principles of the present disclosure. In the drawings:

FIG. 1 is a frame format indicating an alloy particle taking a truncated octahedron shape;

FIG. 2 is a graph showing a relationship between an average particle diameter of the alloy particle shown in FIG. 1 and a ratio of a Miller index {111} surface being exposed to outer surface;

FIG. 3 is a chart showing an X-ray diffraction pattern of an alloy catalyst of an example and a platinum catalyst of a reference example;

FIG. 4 is a TEM image of the alloy catalyst of the example at 125.000-fold magnifications;

FIG. 5 is a SEM image of the alloy catalyst of the example at 2,000,000-fold magnifications;

FIG. 6 is a high resolution TEM image of the alloy catalyst of the example at 4,000,000-fold magnifications, and FIG. 6(a) is a high resolution TEM image of an alloy particle A, FIG. 6(b) is a high resolution TEM image of an alloy particle B, and FIG. 6(c) is a high resolution TEM image of an alloy particle C;

FIG. 7 is a pseudo electron diffraction pattern of the alloy catalyst of the example, and FIG. 7(a) is a pseudo electron diffraction pattern of the alloy particle A, FIG. 7(b) is a pseudo electron diffraction pattern of the alloy particle B, and FIG. 7(c) is a pseudo electron diffraction pattern of the alloy particle C;

FIG. 8 is a frame format showing the alloy particle taking the truncated octahedron shape, and FIG. 8(a) is a view shown from a predetermined angle α, and FIG. 8(b) is a view shown from a predetermined angle β;

FIG. 9 is a frame format showing the alloy particle taking the truncated tetrahedron shape, and FIG. 9(a) is a perspective view, and FIG. 9(b) is a view shown from a predetermined angle γ; and

FIG. 10 is a graph showing the catalytic activity of the alloy catalyst of the example, the alloy catalyst of the comparative example, and the platinum catalyst of the reference example.

### DETAILED DESCRIPTION OF THE PREFERRED EMBODIMENTS

Next, an embodiment of the present invention will be now described in further detail with reference to the accompanying drawings. An alloy catalyst for redox reaction of the present embodiment comprises alloy particles of platinum and nickel, wherein the alloy particle is equipped at the outer surface with a crystal lattice plane represented by a Miller index {111}, and has an average particle diameter in the range of from 6 to 20 nm.

The crystal lattice plane represented by the Miller index {111} indicates a plane group equivalent to a crystal lattice plane represented by the Miller index (111), and includes the crystal lattice planes represented by the Miller indices (−111), (1-11), (11-1) and the like.

According to the alloy catalyst for redox reaction of the present invention, the alloy particles are equipped at the outer surface with the crystal lattice plane represented by the Miller index {111}, and has an average particle diameter in the range of from 6 to 20 nm, so that it becomes possible to obtain superior catalyst activity.

In the alloy catalyst for redox reaction of the present invention, the alloy particles take a shape selected from any one of a regular octahedron, a truncated octahedron, a regular tetrahedron, or a truncated tetrahedron. The truncated octahedron is a shape in which each apex of the regular octahedron is cut off, and the truncated tetrahedron is a shape in which each apex of the regular tetrahedron is cut off.

According to the alloy catalyst for redox reaction of the present embodiment, it becomes possible for the alloy particles to be equipped at the outer surface with the crystal lattice plane represented by the Miller index {111} by taking any one of the shapes mentioned above, and to obtain superior catalyst activity.

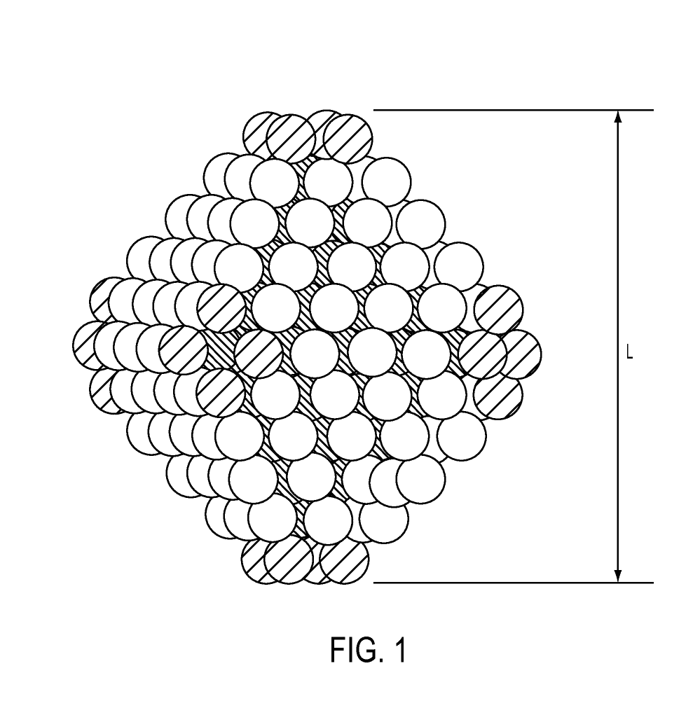

As one example, a frame format showing the alloy particles having the truncated octahedron shape is shown in FIG. 1. In FIG. 1, white balls without hatched lines indicate, of the atoms constituting the truncated octahedron, the atoms exposed to the outer surface and forming the crystal lattice plane represented by the Miller index {111}. Further, in FIG. 1, balls with hatched lines extending from upper right to lower left indicate the atoms exposed to the outer surface and forming the crystal lattice plane represented by the Miller index {100}. Still further, balls with hatched lines extending from upper left to lower right in FIG. 1 indicate the atoms not exposed to the outer surface.

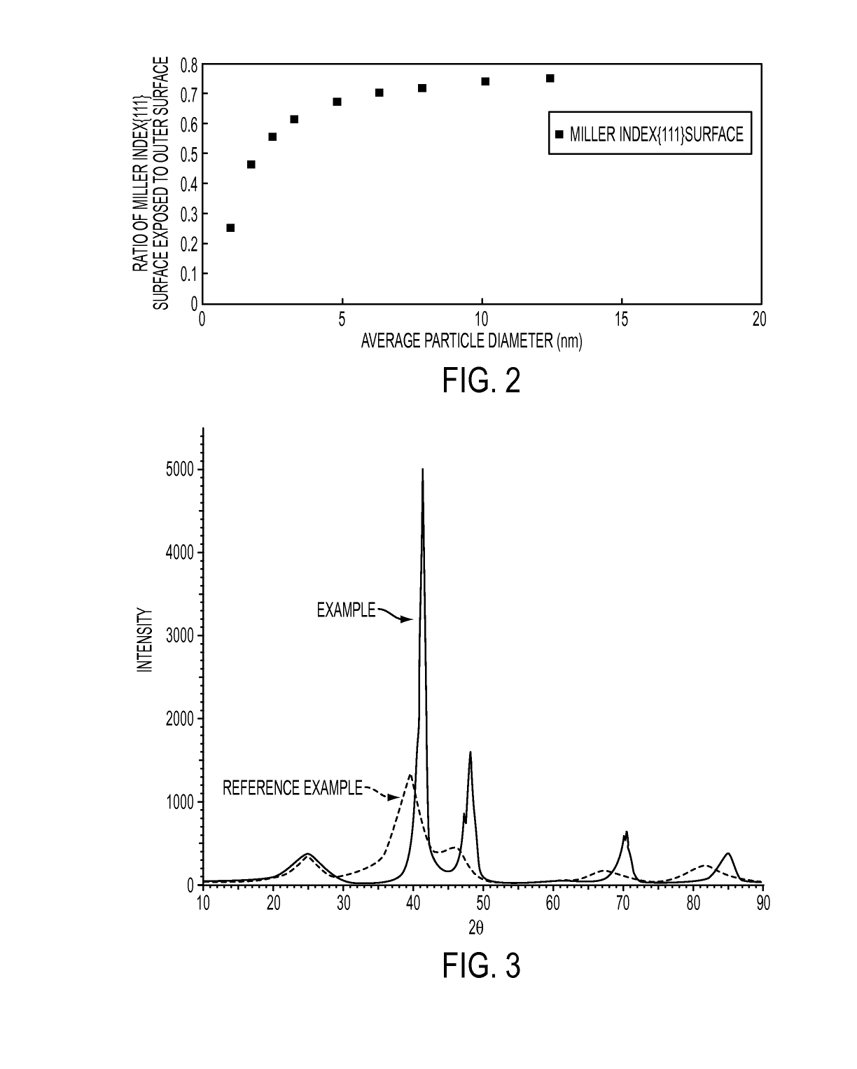

Next, for the alloy particles shown in FIG. 1, a ratio of the crystal lattice plane represented by the Miller index {111} exposed to the outer surface in the case where the average particle diameter is changed was calculated. In the case of the alloy particles taking the truncated octahedron shape, the particle diameter indicates the distance between two opposing surfaces in the truncated octahedron, as is shown by reference L in FIG. 1. FIG. 2 indicates the relationship between the average particle diameter and the ratio of the Miller index {111} surface exposed to outer surface.

It is apparent from FIG. 2 that, in the alloy particles taking the shape of the truncated octahedron, the ratio of the crystal lattice plane represented by the Miller index {111} exposed to outer surface becomes higher as the average particle diameter becomes larger. Further, in the alloy particles of the truncated octahedron shape, it is apparent that the crystal lattice plane represented by the Miller index {111} is exposed to the outer surface at a region larger than 68% of the overall outer surface, in the case where the average particle diameter is in the range of from 6 to 20 nm.

Therefore, it is apparent that the alloy catalyst for redox reaction of the present embodiment comprising the alloy particles having the truncated octahedron shape may be equipped at the outer surface with, in the case where the alloy particles has an average particle diameter in the range of from 6 to 20 nm, the crystal lattice plane represented by the Miller index {111} in a ratio sufficient for obtaining superior catalyst activity.

Next, an example and a comparative example of the present invention will be explained.

### Example

In the present example, first, 24 mg of platinum acetylacetonate, 15 mg of nickel acetate tetrahydrate, 50 mL of ethylene glycol, and 26 μL of polydiallyldimethylammonium chloride (PDDA) were mixed in a three neck flask, so as to obtain a mixed liquid.

Next, while introducing argon to the mixed liquid, the mixed liquid was heated to reflux at a temperature of 140° C. for two hours. By being heated to reflux, the mixed liquid turned black. Next, the mixed liquid heated to reflux was cooled to room temperature by placing the same in atmosphere, so as to obtain a catalyst solution.

Next, the obtained catalyst solution was added with 144 g of carbon black powder (manufactured by Lion Corporation, product name: carbon ECP), and was mixed by stirring at a room temperature (20° C.) for twelve hours with a magnetic stirrer.

The catalyst solution mixed with carbon black powder was performed with suction filtration using filter paper (manufactured by Kiriyama Glass Company, product name: Kiriyama funnel filter paper No. 6). The filter paper has a pore diameter of 3 μm or less. Next, residues remaining on the filter paper were taken out, and was heat treated at a temperature of 300° C. for two hours under a mixed gas atmosphere, the mixed gas being a mixture of hydrogen and argon at a volume ratio of 4:96. By doing so, the alloy catalyst for redox reaction (hereinafter referred to as alloy catalyst) of the present example supported by carbon black powder was obtained.

Next, the alloy catalyst of the present example supported by carbon black powder was first performed with X-ray diffraction using an X-ray diffractometer. Cu was used as the radiation source. FIG. 3 shows the obtained X-ray diffraction pattern.

Next, as a reference example, the X-ray diffraction was performed to a platinum catalyst (manufactured by Tanaka Kikinzoku Kogyo K.K., product name: TEC10V30E, platinum support quantity of 30% by mass) supported by carbon black powder in the exact same manner as with the present example. FIG. 3 shows the obtained X-ray diffraction pattern.

As is shown in FIG. 3, the main peak of the platinum catalyst of the reference example lies in the vicinity of 20=40°, whereas the main peak of the alloy catalyst of the present example lies in the vicinity of 2θ=41.5°. Therefore, it is apparent that the alloy catalyst of the present example has its main peak shifted to a high angle side compared to the platinum catalyst of the reference example, and it is apparent that the platinum and nickel are alloyed.

Further, the average particle diameter of the alloy catalyst obtained in the present example calculated using a Scherrer's equation shown in equation (3) below, from the main peak in FIG. 3, was 8.5 nm.

L=Kλ/(β cos θ) (3)

where L: average particle diameter, K: constant (0.9), λ: wavelength (1.54 Å), β: full width at half maximum.

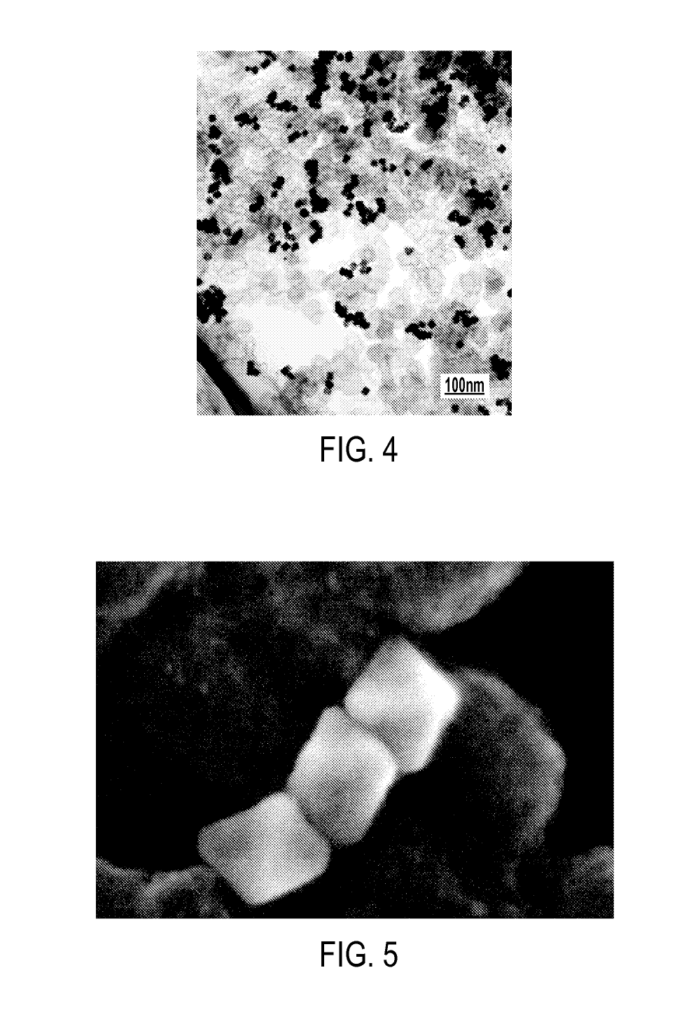

Next, the alloy catalyst of the present example supported by carbon black powder was observed using a transmission electron microscope (TEM). FIG. 4 shows the obtained TEM image. As is shown in FIG. 4, it is apparent that the alloy catalyst obtained in the present example is an aggregate of alloy particles taking any one of a square, a lozenge, and a triangle shape in a planar view.

The average particle diameter was calculated for the alloy particle, by image processing the TEM image, and the result was 16.7 nm.

From the calculation result, the average particle diameter of the alloy particles of the present example may be estimated to be in the range of from 8.5 to 16.7 nm.

Next, the alloy catalyst of the present example supported by carbon black powder was observed using a scanning electron microscope (SEM). As a result, it turned out that the alloy catalyst obtained in the present example was an aggregate of the alloy particles of a shape of any one of the regular octahedron, the truncated octahedron, the regular tetrahedron, and the truncated tetrahedron. FIG. 5 shows an SEM image of the alloy particle taking the truncated octahedron shape, out of the alloy catalyst obtained in the present example.

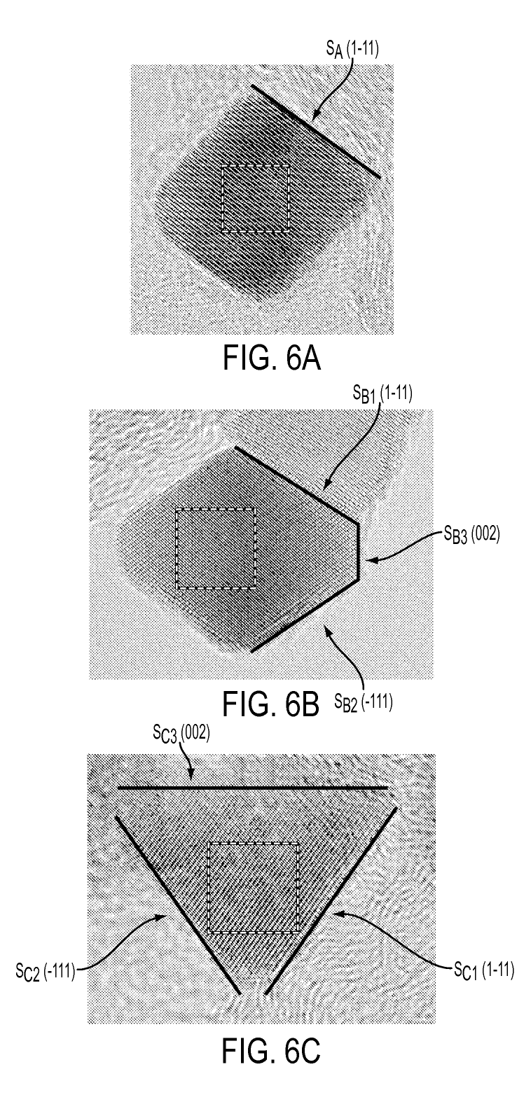

Next, the alloy catalyst of the present example supported by carbon black powder was observed using a high resolution transmission electron microscope (manufactured by Hitachi High-Technologies Corporation, product name: H-9000UHR, high resolution TEM). FIG. 6(a), (b), and (c) shows the high resolution TEM image of the alloy particles A, B, and C constituting the alloy catalyst of the present example.

It is apparent from FIG. 6(a) that the alloy particle A is of an octagonal shape which lacks four corners of the rectangle in a planar view. Further, it is apparent from FIG. 6(b) that the alloy particle B is of a hexagonal shape which lacks two corners of a lozenge in a planar view. Still further, it is apparent from FIG. 6(c) that the alloy particle C is of a hexagonal shape which lacks three corners of a triangle in a planar view.

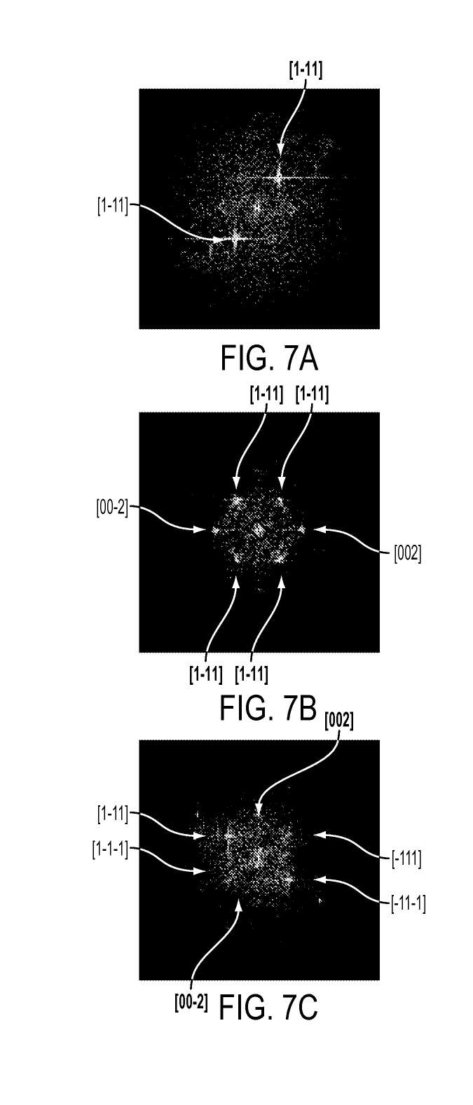

Next, a pseudo electron diffraction pattern was obtained by processing with fast Fourier Transform algorithm a rectangle region surrounded by a dotted line in each of FIG. 6(a), (b) and (c). The results are shown in FIG. 7(a), (b) and (c).

It is apparent from FIG. 7(a) that the alloy particle A has electron diffraction points at the position of [1-11] and [−11-1]. Therefore, it is apparent that the Miller index of a surface S_{A} in FIG. 6(a) is (1-11). Because the crystal lattice plane represented by the Miller index (1-11) is equivalent to the crystal lattice plane represented by the Miller index (111), it is apparent that the alloy particle A constituting the alloy catalyst obtained in the present example is equipped at the outer surface with the crystal lattice plane represented by the Miller index {111}.

Further, it is apparent from FIG. 7(b) that the alloy particle B has electron diffraction points at the position of [1-11], [-11-1], [-111], [1-1-1], [002], and [00-2]. Therefore, it is apparent that, in FIG. 6(b), the Miller index of a surface S_{B1} is (1-11), the Miller index of a surface S_{B2} is (−111), and the Miller index of a surface S_{B3} is (002). Because the crystal lattice plane represented by the Miller index (1-11) and the crystal lattice plane represented by the Miller index (−111) are equivalent to the crystal lattice plane represented by the Miller index (111), it is apparent that the alloy particle B constituting the alloy catalyst of the present example is equipped at the outer surface with the crystal lattice plane represented by the Miller index {111}.

Still further, it is apparent from FIG. 7(c) that the alloy particle C has electron diffraction points at the position of [1-11], [−11-1], [−111], [1-1-1], [002], and [00-2]. Therefore, it is apparent that, in FIG. 6(c), the Miller index of a surface S_{C1} is (1-11), the Miller index of a surface S_{C2} is (−111), and the Miller index of a surface S_{C3} is (002). Because the crystal lattice plane represented by the Miller index (1-11) and the crystal lattice plane represented by the Miller index (−111) are equivalent to the crystal lattice plane represented by the Miller index (111), it is apparent that the alloy particle C constituting the alloy catalyst of the present example is equipped at the outer surface with the crystal lattice plane represented by the Miller index {111}.

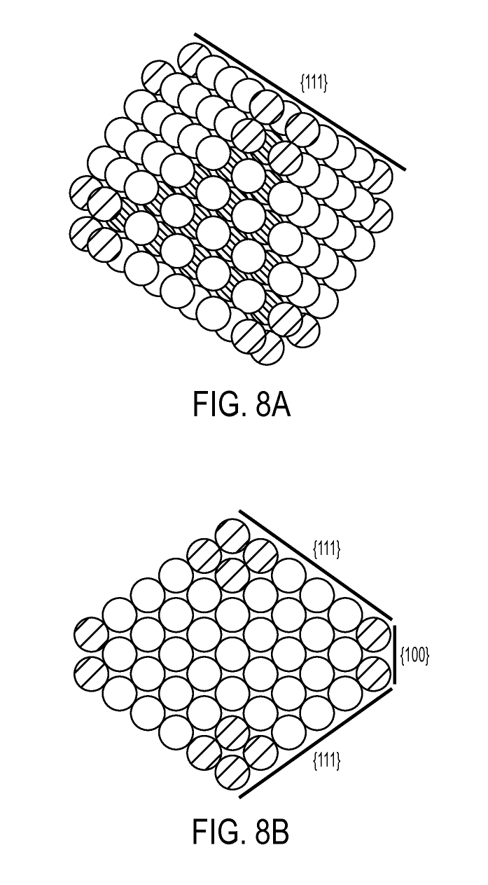

Next, FIG. 8(a) shows the alloy particle of the truncated octahedron shape shown in FIG. 1 rotated and seen from a predetermined angle α. The alloy particle shown in FIG. 8(a) is of an octagonal shape with four corners of a rectangle cut off, and is equipped at the outer surface with the crystal lattice plane represented by the Miller index {111}, and conforms to the result of the high resolution TEM image of the alloy particle A shown in FIG. 6(a). Therefore, it is apparent that the alloy particle A constituting the alloy catalyst obtained in the present example takes the truncated octahedron shape, and is equipped at the outer surface with the crystal lattice plane represented by the Miller index {111}.

FIG. 8(b) shows the alloy particle of the truncated octahedron shape shown in FIG. 1 rotated and seen from a predetermined angle β. The alloy particle shown in FIG. 8(b) is of a hexagonal shape with two corners of a lozenge cut off, and is equipped at the outer surface with the crystal lattice plane represented by the Miller index {111}, and conforms to the result of the high resolution TEM image of the alloy particle B shown in FIG. 6(b). Therefore, it is apparent that the alloy particle B constituting the alloy catalyst obtained in the present example takes the truncated octahedron shape, and is equipped at the outer surface with the crystal lattice plane represented by the Miller index {111}.

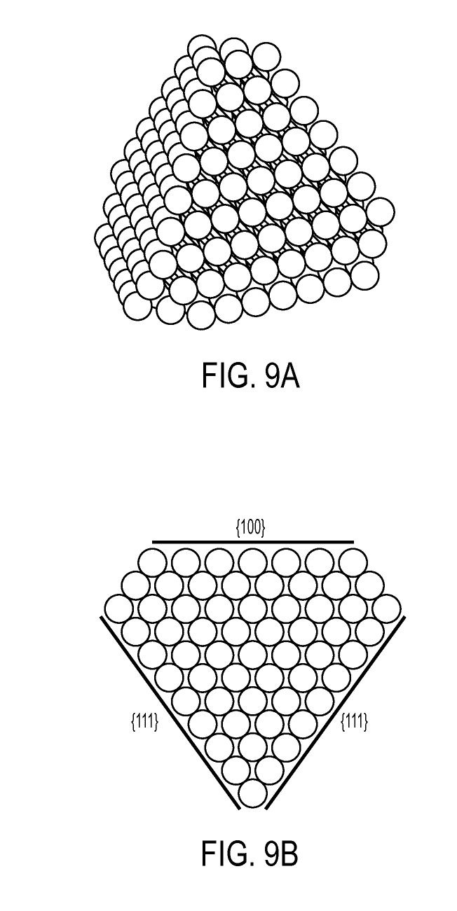

Next, FIG. 9(a) shows a frame format of the alloy particle of the truncated tetrahedron shape. In FIG. 9(a), white balls without hatched lines indicate, of the atoms constituting the truncated tetrahedron, the atoms exposed to the outer surface and at the same time forming the crystal lattice plane represented by the Miller index {111}. Further, in FIG. 9(a), balls with hatched lines indicate the atoms not exposed to the outer surface.

Next, FIG. 9(b) shows the alloy particle of the truncated tetrahedron shape shown in FIG. 9(a) rotated and seen from a predetermined angle γ. The alloy particle shown in FIG. 9(b) is of a hexagonal shape with three corners of a triangle cut off, and is equipped at the outer surface with the crystal lattice plane represented by the Miller index {111}, and conforms to the result of the high resolution TEM image of the alloy particle C shown in FIG. 6(c). Therefore, it is apparent that the alloy particle C constituting the alloy catalyst obtained in the present example takes the truncated tetrahedron shape, and is equipped at the outer surface with the crystal lattice plane represented by the Miller index {111}.

Next, composition analysis was performed to the alloy catalyst of the present example supported by carbon black powder using an energy dispersive X-ray spectrometer. As a result, atomic ratio of platinum:nickel of the alloy catalyst obtained in the present example was 66:34.

Next, the catalytic activity of the alloy catalyst of the present example supported by carbon black powder was evaluated using a rotating disk electrode method (RDE). First, 1 g of carbon black powder supporting the alloy catalyst obtained in the present example was mixed in 1 L of water, and the obtained mixed liquid was dispersed by irradiating ultrasonic waves at frequency of 20 kHz and output of 200 W for five minutes using an ultrasonic homogenizer. Next, 15 μL of the obtained dispersion liquid was dropped on the surface of the rotating electrode made of glassy carbon having a diameter of 5 mm and thickness of 4 mm, and was dried in atmosphere under room temperature. By doing so, water contained in the dispersion liquid was evaporated and the alloy catalyst included in the dispersion liquid was attached onto the surface of the rotating electrode.

Next, 15 μL, of 0.05 weight % water solution of Nafion (registered trademark) was dropped on the rotating electrode attached with the alloy catalyst of the present example, and was dried in atmosphere under room temperature. By doing so, water contained in the water solution was evaporated and the surface of the rotating electrode was coated with Nafion. As such, the alloy catalyst of the present example supported by carbon black powder was applied onto the rotating electrode.

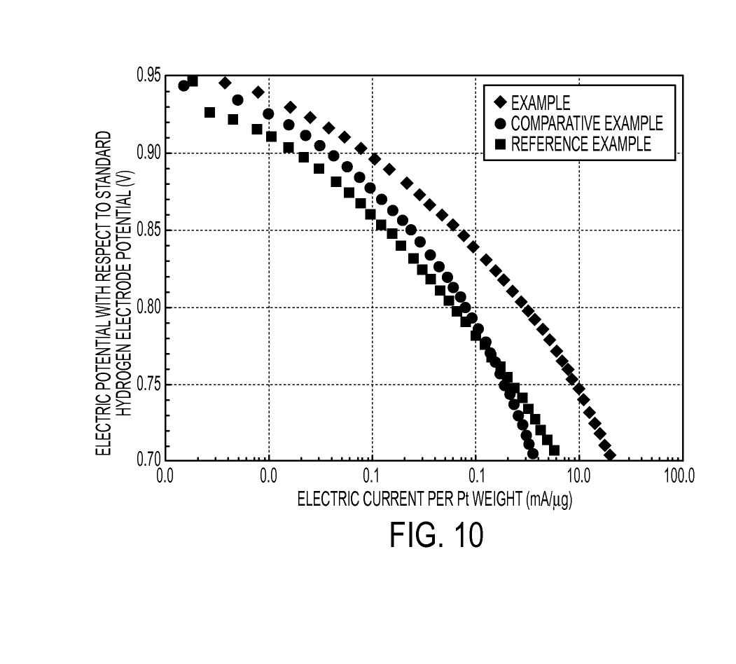

Next, a three-electrode type cell was prepared using the rotating electrode applied with the alloy catalyst of the present example supported by carbon black powder, and electrochemical measurement was carried out. First, while rotating the rotating electrode applied with the alloy catalyst of the present example in 280 mL of oxygen saturated perchlorate aqueous solution with a concentration of 0.1 mol/L, current values were measured by polarizing at an electric potential in the range of from 0 to 1 V with respect to the standard hydrogen electrode potential, at an operational speed of 5 mV/sec. The results are shown in FIG. 10. The horizontal axis in FIG. 10 is a value obtained by dividing the obtained current value by a Pt weight contained in the alloy catalyst applied to the rotating electrode. From FIG. 10, it is apparent that, in the alloy catalyst of the present example, the current value per Pt weight when the electrical potential with respect to the standard hydrogen electrode potential is 0.9V was 0.076 mA/μg-Pt.

Further, the catalytic activity of the platinum catalyst of the present reference example was evaluated in the exact same manner as with the present example. The results are shown in FIG. 10. From FIG. 10, it is apparent that the current value per Pt weight when the electrical potential with respect to the standard hydrogen electrode potential is 0.9V was 0.016 mA/μg-Pt.

Next, from the obtained current value per Pt weight when the electrical potential with respect to the standard hydrogen electrode potential is 0.9V, the catalytic activity (ratio of catalytic activity) of the alloy catalyst of the present example with respect to the platinum catalyst of the present reference example was calculated. The result is shown in Table 1.

Next, stability with respect to repetition of the electrochemical redox reaction was evaluated. The evaluation on stability was performed using the three-electrode type cell and rotating the rotating electrode applied with the alloy catalyst of the present example in 280 mL of oxygen saturated perchlorate aqueous solution with a concentration of 0.1 mol/L.

The potential sweeping in the range of from 0.6 to 0.9V with respect to the standard hydrogen electrode potential at the operating speed of 400 mV/sec while rotating the rotating electrode was repeated for 10,000 cycles. Thereafter, the current values were measured by polarizing at an electric potential in the range of from 0 to 1 V with respect to the standard hydrogen electrode potential, at an operational speed of 5 mV/sec.

The alloy catalyst of the present example has the current value per Pt weight when the electrical potential with respect to the standard hydrogen electrode potential is 0.9 V of 0.068 mA/μg-Pt, and a rate of change of performance with respect to initial state was −11%. The results are shown in Table 2.

After measuring the current value, the alloy catalyst of the present example supported by carbon black powder was collected from the rotating electrode, and the TEM image of the alloy catalyst was obtained. The average particle diameter of the alloy particle was calculated by image processing the obtained TEM image, and the result was 18.1 nm, and the rate of change of the average particle diameter with respect to initial state (16.7 nm) was +8%. The results are shown in Table 3.

### Comparative Example

In the present comparative example, first, 32 mg of chloroplatinic acid hexahydrate, 15 mg of nickel chloride hexahydrate, 50 mg of polyvinylpyrrolidone, and 50 mL of ultrapure water were mixed in a three neck flask, so as to obtain a mixed liquid.

Next, a catalyst solution was obtained by adding 65 mg of sodium tetrahydroborate (NaBH₄) to the mixed liquid, and stirring under room temperature (20° C.) for two hours. Next, to the obtained catalyst solution, carbon black powder was added and then mixed in the exact same manner as with the example. Thereafter, the alloy catalyst for redox reaction (hereinafter referred to as the alloy catalyst) of the present comparative example supported by carbon black powder was obtained, by performing suction filtration to the catalyst solution mixed with carbon black powder, taking out the residues and heat treating the same, in the exact same manner as with the example.

Next, the average particle diameter of the alloy catalyst of the present comparative example supported by carbon black powder was calculated from TEM image in the exact same manner as with the example, and the result was 2.5 nm.

Next, composition analysis was performed to the alloy catalyst of the present comparative example supported by carbon black powder in the exact same manner as with the example. As a result, atom ratio of platinum:nickel of the alloy catalyst obtained in the present comparative example was 51:49.

Next, the catalytic activity of the alloy catalyst of the present comparative example supported by carbon black powder was evaluated in the exact same manner as with the example. The result is shown in FIG. 10. From FIG. 10, it is apparent that, in the alloy catalyst of the present comparative example, the current value per Pt weight when the electric potential with respect to the standard hydrogen electrode potential is 0.9 V was 0.032 mA/μg-Pt.

Next, from the obtained current value per Pt weight when the electric potential with respect to the standard hydrogen electrode potential is 0.9 V, the catalytic activity (ratio of catalytic activity) of the alloy catalyst of the present comparative example with respect to the platinum catalyst of the reference example was calculated. The result is shown in Table 1.

Next, stability with respect to repetition of the electrochemical redox reaction was evaluated in the exact same manner as with the example. The alloy catalyst of the present comparative example had the current value per Pt weight when the electric potential with respect to the standard hydrogen electrode potential is 0.9 V of 0.013 mA/μg-Pt, and the change rate of performance with respect to the initial state was −59%. The results are shown in Table 2.

After the measurement of the current value, the average particle diameter of the alloy particle was calculated for the alloy catalyst of the present comparative example in the exact same manner as with the example. The average particle diameter of the alloy particle of the alloy catalyst of the present comparative example was 5.2 nm, and the rate of change of the average particle diameter with respect to the initial state (2.5 nm) was +108%. The results are shown in Table 3.

TABLE 1

| | Current value per Pt weight | |
|---|---|---|
| | when electric potential with | |
| | respect to standard | |
| | hydrogen electrode | |
| | potential is 0.9 V | Ratio of catalytic |
| | (mA/μg-Pt) | activity |
| Example | 0.076 | 4.7 |
| Comparative | 0.032 | 2.0 |
| example | | |
| Reference example | 0.016 | 1 |

From Table 1, it is apparent that the ratio of catalytic activity of the alloy catalyst of the example is 4.7 whereas the ratio of catalytic activity of the alloy catalyst of the comparative example is 2.0, and that the alloy catalyst of the example has 2.3 times higher ratio of catalytic activity compared to the alloy catalyst of the comparative example.

TABLE 2

| | | Current value | Rate of change |
|---|---|---|---|
| | Current value | after 10,000 | of current |
| | at initial state | cycles | value |
| | (mA/μg-Pt) | (mA/μg-Pt) | (%) |
| Example | 0.076 | 0.068 | −11 |
| Comparative | 0.032 | 0.013 | −59 |
| Example | | | |

Current value is the current value per Pt weight when electric potential with respect to standard hydrogen electrode potential is 0.9 V

From Table 2, it is apparent that the rate of change of the current value of the alloy catalyst of the present example is smaller than that of the alloy catalyst of the comparative example even when the electrochemical redox reaction is repeated, and that the decrease in the catalyst performance is smaller.

TABLE 3

| | | Average particle | Rate of change |
|---|---|---|---|
| | Average particle | diameter after | of average |
| | diameter at | 10,000 cycles | particle |
| | initial state (nm) | (nm) | diameter (%) |
| Example | 16.7 | 18.1 | +8 |
| Comparative | 2.5 | 5.2 | +108 |
| example | | | |

From Table 3, it is apparent that the growth of the alloy particle which is shown by the increase in the average particle diameter of the alloy catalyst of the present example is smaller than that of the alloy catalyst of the comparative example, even when the electrochemical redox reaction is repeated.

Therefore, it is apparent that the alloy catalyst of the present example is equipped with superior catalytic activity to the redox reaction, compared to the alloy catalyst of the comparative example.

All publications, articles, papers, patents, patent publications, and other references cited herein are hereby incorporated by reference herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What is claimed is:

1. An alloy catalyst for redox reaction comprising alloy particles of platinum and nickel,
wherein the alloy particles are equipped at an outer surface with a crystal lattice plane represented by a Miller index {111}, and have an average particle diameter in a range of from 6 to 20 nm.

2. The alloy catalyst for redox reaction according to claim 1, wherein the alloy particles comprise a shape selected from any one of a regular octahedron, a truncated octahedron, a regular tetrahedron, and a truncated tetrahedron.

3. The alloy catalyst for redox reaction according to claim 1, wherein the atomic ratio of Pt/Ni of the alloy particles is greater than 50/50.

4. The alloy catalyst for redox reaction according to claim 3, wherein the atomic ratio of Pt/Ni of the alloy particles is greater than 65/35.

5. The alloy catalyst for redox reaction according to claim 1, wherein the alloy particles have average particle diameter that are not less than 6 nm.

6. The alloy catalyst for redox reaction according to claim 1, wherein the alloy catalyst comprises alloy particles supported on a high surface area support material.

7. The alloy catalyst for redox reaction according to claim 6, wherein the high surface area support material comprises carbon black.

8. An electrode for redox reactions comprising alloy particles of platinum and nickel,
wherein the alloy particles are equipped at an outer surface with a crystal lattice plane represented by a Miller index {111}, and have an average particle diameter in a range of from 6 to 20 nm.

9. The electrode for redox reaction according to claim 8, wherein the alloy particles comprise a shape selected from any one of a regular octahedron, a truncated octahedron, a regular tetrahedron, and a truncated tetrahedron.

10. The electrode for redox reaction according to claim 8, wherein the atomic ratio of Pt/Ni of the alloy particles is greater than 50/50.

11. The electrode for redox reaction according to claim 10, wherein the atomic ratio of Pt/Ni of the alloy particles is greater than 65/35.

12. The electrode for redox reaction according to claim 8, wherein the alloy particles have average particle diameter that are not less than 6 nm.

13. The electrode for redox reaction according to claim 8, wherein the alloy particles comprises alloy particles supported on a high surface area support material.

14. The electrode for redox reaction according to claim 13, wherein the high surface area support material comprises carbon black.
